(19) United States
(12) Patent Application Publication
(10) Pub. No.: US 2024/0179432 A1
(43) Pub. Date: May 30, 2024

(54) SOLID-STATE IMAGING ELEMENT AND SOLID-STATE IMAGING DEVICE

(71) Applicant: SONY SEMICONDUCTOR SOLUTIONS CORPORATION, KANAGAWA (JP)

(72) Inventors: KAZUKI HARAGUCHI, KANAGAWA (JP); SACHIO AKEBONO, KANAGAWA (JP)

(21) Appl. No.: 18/551,693

(22) PCT Filed: Feb. 15, 2022
(86) PCT No.: PCT/JP2022/005841

§ 371 Date: Sep. 21, 2023

(30) Foreign Application Priority Data
Mar. 31, 2021 (JP) 2021-061626

(51) Int. Cl. H04N 25/709

(52) U.S. Cl. CPC H04N 25/709

(57) ABSTRACT

A dither is effectively applied. A solid-state imaging element includes a pixel array, a horizontal direction controller, a comparator, and a column power supply controller. The pixel array includes pixels that photoelectrically convert received light and output signals, the pixels being provided in an array. The horizontal direction controller selects a line of the pixel array and controls output the signals from the pixels belonging to the line. The comparator includes a plurality of column comparison circuits that compares the signals output from the pixels for every column of the pixel array. The column power supply controller controls a power supply voltage to each of the column comparison circuits.

### TECHNICAL FIELD

The present disclosure relates to a solid-state imaging element and a solid-state imaging device.

### BACKGROUND ART

In an imaging device, there is a method of acquiring a pixel value by outputting a received signal via a vertical signal line on the basis of a column in each line in accordance with a line control signal and horizontally transferring the output signal. In such a method, a voltage and charge of a pixel circuit are reset all at once in order to transfer a light reception signal for every line selection control. When the resets are executed all at once, an influence of power supply variation or the like may occur, and the signal output from the pixel circuit may be affected. In addition, vertical streaks due to quantization errors may appear. Meanwhile, by utilizing the fact that an amplitude of feed-through to a signal line at the time of pixel reset and a settling time of the feed-through are different for every pixel, a dither effect may be generated by causing variations at a timing of non-settling, such as by distributing reset levels in a column direction.

However, a feed-through signal generated in the pixel propagates to a comparison device through the vertical signal line, and a feed-through component at an input end of the comparison device is attenuated by a parasitic resistor of the vertical signal line. In addition, the parasitic resistor of the vertical signal line appears larger for a pixel line farther from the comparison device, and smaller for a pixel line closer to the comparison device. Therefore, there is a problem that the dither effect is relatively different depending on a distance from the comparison device.

Specifically, when a dither amount is adjusted in accordance with the line close to the comparison device, an expected dither amount cannot be obtained in a far line. On the other hand, when the dither amount is adjusted in accordance with the line far from the comparison device, an excessive dither is obtained in the close line. In recent years, in order to acquire a still image or a moving image with high resolution and high sensitivity, an increase in area and an increase in number of pixels have progressed, and a perspective end difference has increased. Therefore, a difference in parasitic resistor between the comparison device and a far pixel line and a close pixel line is inevitably large. Since a period during which AD conversion is performed is determined so as to include count variation for each column due to dither, excessive dither can be a factor that extends the AD period. As a result, there is a high probability that a disadvantage occurs in terms of processing speed.

### CITATION LIST

### Patent Document

Patent Document 1: Japanese Patent Application Laid-Open No. 2009-038834

### SUMMARY OF THE INVENTION

### Problems to be Solved by the Invention

Therefore, the present disclosure provides a solid-state imaging device that effectively applies a dither.

### Solutions to Problems

In an embodiment, a solid-state imaging element includes a pixel array, a horizontal direction controller, a comparator, and a column power supply controller. The pixel array includes pixels that photoelectrically convert received light and output signals, the pixels being provided in an array. The horizontal direction controller selects a line of the pixel array and controls output the signals from the pixels belonging to the line. The comparator includes a plurality of column comparison circuits that compares the signals output from the pixels for every column of the pixel array. The column power supply controller controls a power supply voltage to each of the column comparison circuits.

The column power supply controller may apply n (n>=2) types of power supply voltages to each of the plurality of column comparison circuits.

The column power supply controller may include a circuit configured to generate n types of potentials.

The column power supply controller may include n control lines that transmit the n types of potentials.

The column power supply controller may apply the same power supply voltage to every m (m>=2) column comparison circuits among the plurality of column comparison circuits.

The column power supply controller may include a selector that connects the n control lines to the plurality of column comparison circuits at an m-column cycle.

The selector may transition a connection status between the n control lines and the plurality of column comparison circuits in the m-column cycle for every AD conversion.

The selector may transition the connection status for every AD conversion periodically with respect to time.

The selector may transition the connection status for every AD conversion on the basis of a random number.

The column power supply controller may, to the n control lines, output the n types of potentials at a timing of resetting the plurality of column comparison circuits, and output one type of potential at a timing of AD conversion.

The column power supply controller may include a switch that controls short-circuiting and opening of a power supply line that applies the power supply voltage to each of the plurality of column comparison circuits to the power supply line of another column comparison circuit among the plurality of column comparison circuits, and a switch control circuit that transmits a switch control signal that controls a switching state of the switch.

The column power supply controller may vary the power supply voltage of each of the plurality of column comparison circuits at the timing of resetting the plurality of column comparison circuits and at the timing of AD conversion.

The column power supply controller may control whether or not the power supply voltage is varied for every AD conversion of the plurality of column comparison circuits.

The column power supply controller may control the switch for every AD conversion, and vary a combination of the column comparison circuits to be short-circuited.

In an embodiment, a solid-state imaging device includes an optical system that controls a light receiving environment in the pixels, the solid-state imaging element according to any of the above, and a processing circuit that processes a signal output from the solid-state imaging element.

### BRIEF DESCRIPTION OF DRAWINGS

FIG. 1 is a block diagram schematically illustrating a solid-state imaging device according to an embodiment.

FIG. 2 is a diagram schematically illustrating a solid-state imaging element according to an embodiment.

FIG. 3 is a diagram schematically illustrating a solid-state imaging element according to an embodiment.

FIG. 4 is a diagram schematically illustrating a solid-state imaging element according to an embodiment.

FIG. 5 is a block diagram schematically illustrating a part of a circuit of a solid-state imaging element according to an embodiment.

FIG. 6 is a circuit diagram illustrating an example of a column power supply controller and a comparator according to an embodiment.

FIG. 7 is a circuit diagram illustrating an example of selector according to an embodiment.

FIG. 8 is a timing chart in a circuit of a solid-state imaging element according to an embodiment.

FIG. 9 is a table illustrating an example of a column power supply control according to an embodiment.

FIG. 10 is a table illustrating an example of a column power supply control according to an embodiment.

FIG. 11 is a circuit diagram illustrating an example of a column power supply controller according to an embodiment.

FIG. 12 is a timing chart in a circuit of a solid-state imaging element according to an embodiment.

FIG. 13 is a timing chart in a circuit of a solid-state imaging element according to an embodiment.

FIG. 14 is a circuit diagram illustrating an example of a delay circuit of a control signal according to an embodiment.

FIG. 15 is a circuit diagram illustrating an example of a delay circuit of a control signal according to an embodiment.

FIG. 16 is a table illustrating an example of a selection of a column to be short-circuited and opened according to an embodiment.

FIG. 17 is a circuit diagram illustrating an example of a column power supply controller and a comparator according to an embodiment.

FIG. 18 is a timing chart in a circuit of a solid-state imaging element according to an embodiment.

FIG. 19 is a circuit diagram illustrating an example of a column power supply controller and a comparator according to an embodiment.

FIG. 20 is a timing chart in a circuit of a solid-state imaging element according to an embodiment.

FIG. 21 is a block diagram illustrating an example of a schematic configuration of a vehicle control system.

FIG. 22 is an explanatory diagram illustrating an example of installation positions of an outside-vehicle information detector and an imaging unit.

### MODE FOR CARRYING OUT THE INVENTION

Hereinafter, embodiments of the present disclosure will be described with reference to the drawings. The drawings are used for description, and the shape and size of the configuration of each unit in the actual device, the ratio of size to other configurations, and the like are not necessarily as illustrated in the drawings. Furthermore, since the drawings are illustrated in a simplified manner, configurations necessary for implementation other than those illustrated in the drawings are appropriately provided.

### First Embodiment

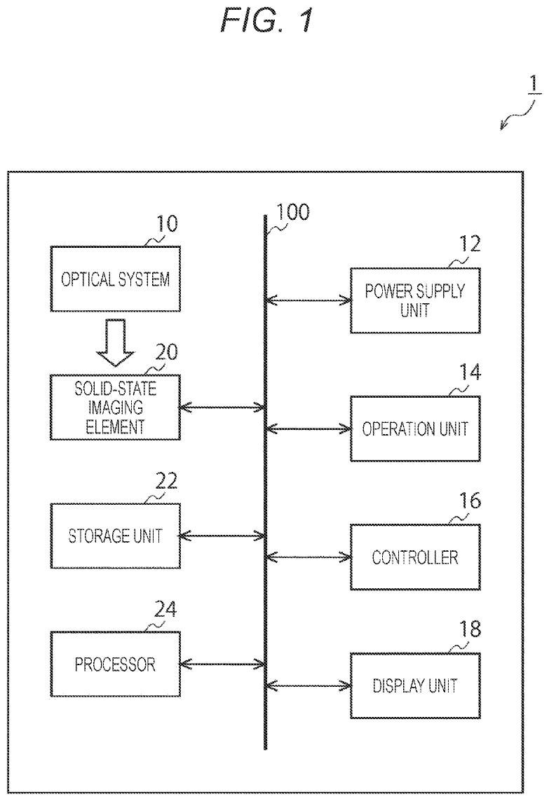

FIG. 1 is a block diagram schematically illustrating a solid-state imaging device according to an embodiment. A solid-state imaging device 1 includes an optical system 10, a power supply unit 12, an operation unit 14, a controller 16, a display unit 18, a solid-state imaging element 20, a storage unit 22, and a processor 24. The solid-state imaging device 1 is a device that converts information acquired from the outside via the optical system 10 into a signal, and appropriately processes, stores, and outputs the signal. For example, each configuration may be connected via a bus 100 included in the solid-state imaging device 1 as necessary, or may be directly connected to another appropriate configuration.

The solid-state imaging device 1 may be, for example, a digital camera such as a digital still camera, a camera mounted on a smartphone, a tablet terminal, a personal computer, or the like having an imaging function, or provided in various housings such as an automobile and a robot.

The optical system 10 is an optical system such as a lens. The optical system 10 is designed and disposed so that light can be appropriately converted into a signal in the solid-state imaging element 20. The optical system 10 may be an independent optical system, or at least a part of the optical system 10 may be a microlens or the like formed integrally with the solid-state imaging element 20 on a light receiver of the solid-state imaging element 20.

The power supply unit 12 has a power supply that appropriately supplies power necessary for operation in each unit of the solid-state imaging device 1.

The operation unit 14 receives an operation by a user, outputs an operation signal according to the operation by the user, and notifies each unit via the bus 100.

The controller 16 is a circuit that executes control of each unit, and appropriately outputs a control signal necessary for controlling each unit.

The display unit 18 includes, for example, a display or the like of an arbitrary format that displays image information or the like acquired by the solid-state imaging element 20 and subjected to appropriate signal processing. In some cases, an image to be used for the operation of the operation unit 14 may be displayed. Furthermore, the operation unit 14 and the display unit 18 may be integrally disposed as, for example, a touch panel or a touch display.

For example, the power supply unit 12, the operation unit 14, and the display unit 18 are not essential configurations of the solid-state imaging device 1, and power, an operation signal, data to be displayed, and the like may be appropriately input and output via an input/output interface (not shown) included in the solid-state imaging device 1.

The solid-state imaging element 20 receives light appropriately condensed via the optical system 10, performs photoelectric conversion, and acquires an analog signal based on an intensity of the received light. The solid-state imaging element 20 includes, for example, a photodiode and an organic photoelectric conversion film. The solid-state imaging element 20 may further include a digital-to-analog converter (DAC), and may convert the analog signal into a digital signal, appropriately perform signal processing, and then output the digital signal.

The storage unit 22 includes a frame memory that temporarily stores a signal output from the solid-state imaging element 20. The storage unit 22 may further include a storage that stores data required for control in the solid-state imaging device 1.

The processor 24 appropriately processes and outputs the signal output from the solid-state imaging element 20. For example, the processor 24 performs processing based on data desired to be acquired or performs image processing on an image signal output from the solid-state imaging element 20, and outputs the image signal to the storage unit 22 or the display unit 18.

The power supply unit 12 has a power supply that appropriately supplies power necessary for operation in each unit of the solid-state imaging device 1.

The operation unit 14 receives an operation by a user, outputs an operation signal according to the operation by the user, and notifies each unit via the bus 100.

The controller 16 is a circuit that executes control of each unit, and appropriately outputs a control signal necessary for controlling each unit.

The display unit 18 includes, for example, a display or the like of an arbitrary format that displays image information or the like acquired by the solid-state imaging element 20 and subjected to appropriate signal processing. In some cases, an image to be used for the operation of the operation unit 14 may be displayed. Furthermore, the operation unit 14 and the display unit 18 may be integrally disposed as, for example, a touch panel or a touch display.

For example, the power supply unit 12, the operation unit 14, and the display unit 18 are not essential configurations of the solid-state imaging device 1, and power, an operation signal, data to be displayed, and the like may be appropriately input and output via an input/output interface (not shown) included in the solid-state imaging device 1.

The solid-state imaging element 20 receives light appropriately condensed via the optical system 10, performs photoelectric conversion, and acquires an analog signal based on an intensity of the received light. The solid-state imaging element 20 includes, for example, a photodiode and an organic photoelectric conversion film. The solid-state imaging element 20 may further include a digital-to-analog converter (DAC), and may convert the analog signal into a digital signal, appropriately perform signal processing, and then output the digital signal.

The storage unit 22 includes a frame memory that temporarily stores a signal output from the solid-state imaging element 20. The storage unit 22 may further include a storage that stores data required for control in the solid-state imaging device 1.

The processor 24 appropriately processes and outputs the signal output from the solid-state imaging element 20. For example, the processor 24 performs processing based on data desired to be acquired or performs image processing on an image signal output from the solid-state imaging element 20, and outputs the image signal to the storage unit 22 or the display unit 18.

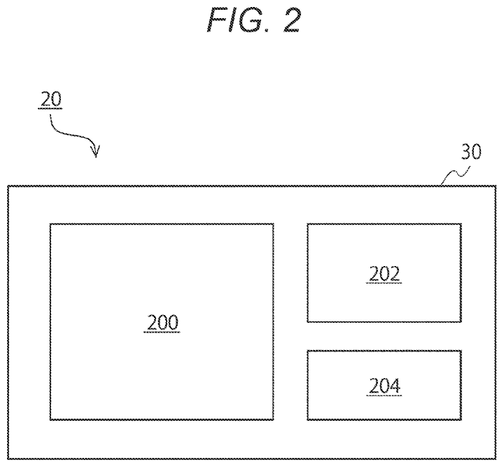

FIG. 2 is an implementation example of the solid-state imaging element 20. The solid-state imaging element 20 includes a light receiving element 200, a storage circuit 202 which is at least a part of the storage unit 22, and a processing circuit 204 which is at least a part of the processor 24 on the same semiconductor substrate 30. As described above, the light receiving element 200, the storage circuit 202, and the processing circuit 204 may be provided on one semiconductor substrate 30. Each unit is connected by an appropriate conductive wire or the like.

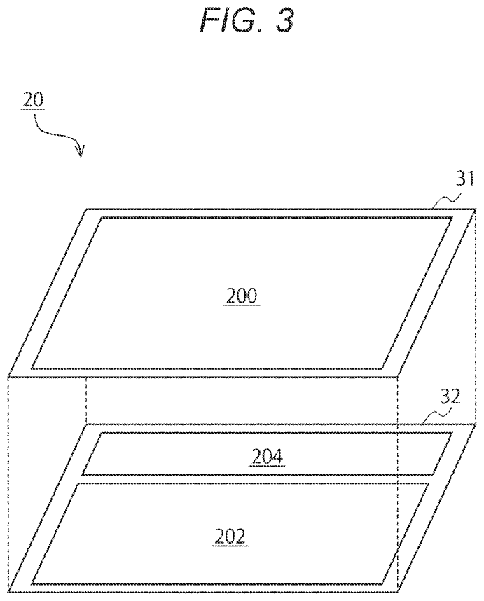

FIG. 3 is another implementation example different from the above. The solid-state imaging element 20 may be mounted on a first semiconductor layer 31 and a second semiconductor layer 32 which are different semiconductor layers. The first semiconductor layer 31 is provided with the light receiving element 200, and the second semiconductor layer 32 is provided with the storage circuit 202 and the processing circuit 204. The first semiconductor layer 31 and the second semiconductor layer 32 are stacked, formed as an integrated semiconductor device, and operate. For example, the first semiconductor layer 31 is disposed closer to the optical system 10 than the second semiconductor layer 32, light via the optical system 10 is received by the first semiconductor layer 31, and a signal is output to the second semiconductor layer 32.

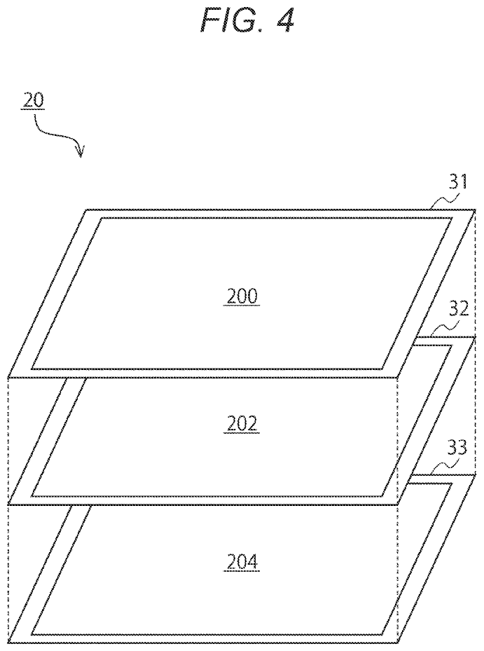

FIG. 4 is another implementation example different from the above. The solid-state imaging element 20 may be mounted on the first semiconductor layer 31, the second semiconductor layer 32, and a third semiconductor layer 33 which are different semiconductor layers. The first semiconductor layer 31 is provided in the light receiving element 200, the second semiconductor layer 32 is provided with the storage circuit 202, and the third semiconductor layer 33 is provided with the processing circuit 204. The first semiconductor layer 31, the second semiconductor layer 32, and the third semiconductor layer 33 are stacked, formed as an integrated semiconductor device, and operate. For example, the first semiconductor layer 31 is disposed closest to the optical system 10, light via the optical system 10 is received by the first semiconductor layer 31, and a signal is output to at least one of the second semiconductor layer 32 or the third semiconductor layer 33.

In the case of the forms illustrated in FIGS. 3 and 4, the stacked semiconductor layers may be formed by, for example, a chip on chip (CoC) method in which the semiconductor layers are cut out from a wafer, divided into individual pieces, and then stacked and bonded to each other vertically. In addition, a chip on wafer (CoW) method may be adopted in which any one layer is cut out and divided into individual pieces, and then bonded to a wafer. Alternatively, a wafer on wafer (WoW) method may be adopted in which pieces of wear are bonded to each other and then divided into individual pieces.

For bonding the semiconductor layers, a via hole, a microbump, a micropad, plasma bonding, or the like can be used as a non-restrictive example. By such a method, the semiconductor layers are appropriately electrically connected and formed so as to be able to transmit and receive signals.

The solid-state imaging element 20 mounted as described above generates image data by photoelectric conversion in synchronization with a vertical synchronization signal Vsync. Here, the vertical synchronization signal Vsync is a periodic signal of a predetermined frequency indicating imaging timing. The solid-state imaging element 20 appropriately outputs image data generated on the basis of the timing indicated by the vertical synchronization signal Vsync via the bus 100.

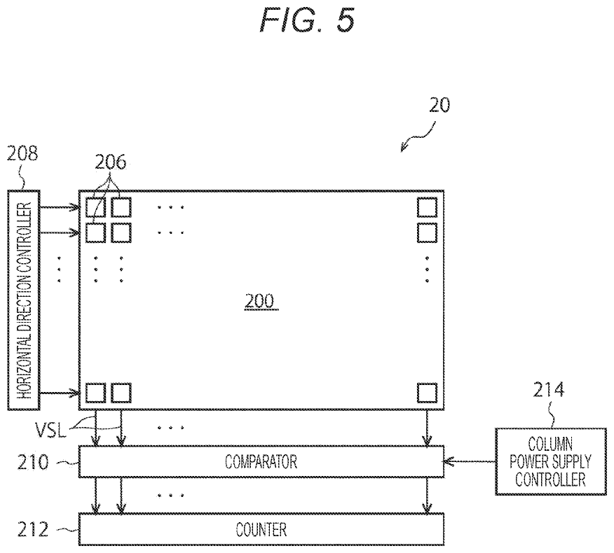

FIG. 5 is a diagram schematically illustrating an example of outputting a signal for every column as an example of outputting a signal from a pixel provided as the light receiving element 200 in the solid-state imaging element 20. An example of performing AD conversion for every column will be described. The light receiving element 200 includes a pixel array in which pixels 206 are provided in an array in a column direction and a line direction.

A horizontal direction controller 208 is a circuit that selects a line of pixels in the pixel array. A line of the pixels 206 in the light receiving element 200 is selected on the basis of a control signal from the horizontal direction controller 208, and pixel signals (analog signals) are output from the pixels belonging to the selected line.

A comparator 210 compares the analog signal from the pixel output for every column with, for example, a ramp signal obtained by converting a digital signal into an analog signal by DA conversion, amplifies the comparison result, and outputs the comparison result for every column.

A counter 212 outputs a pixel value output from each pixel 206 as a digital signal on the basis of the output from the comparator 210.

Although the above is a general configuration, the solid-state imaging element 20 according to the present embodiment further includes a column power supply controller 214. The column power supply controller 214 is a circuit that controls a power supply voltage of a comparison circuit provided for every column in the comparator 210. The solid-state imaging element 20 according to the present embodiment achieves appropriate dithering processing by locally controlling the power supply voltage for every column by the column power supply controller 214.

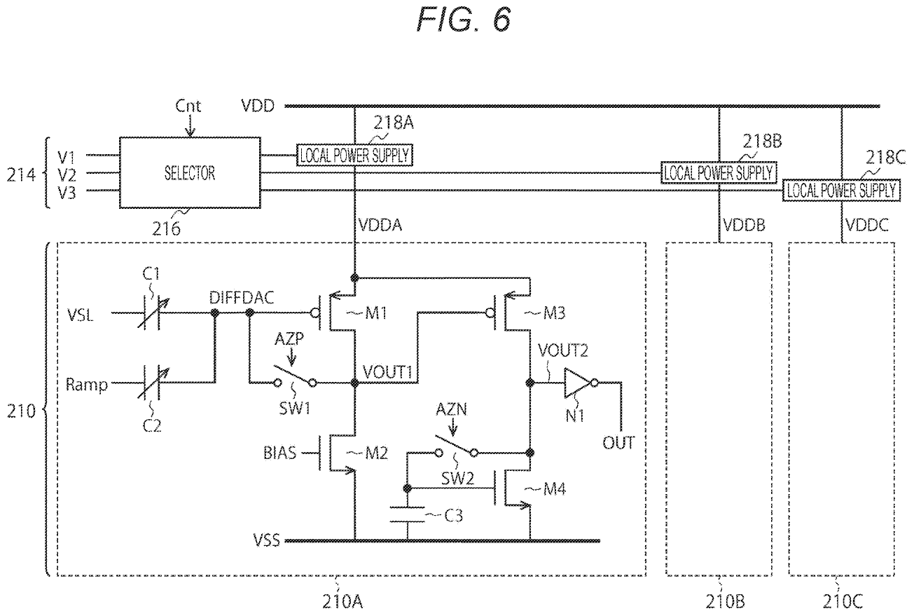

FIG. 6 is a diagram illustrating an example of the comparator 210 and the column power supply controller 214 that controls a local power supply for every column in the solid-state imaging element 20 according to the present embodiment. In the following example, the dither processing is executed by using, for example, three types of local power supply voltages. The three types of voltages are illustrated as a non-restrictive example, and the voltage of the local power supply may be two types or four or more types.

The comparator 210 includes column comparison circuits 210A, 210B, 210C, . . . for every column. Subscripts A, B, and C are characters for identifying a column. Each of the column comparison circuits is desirably configured by the same circuit. Here, the configuration will be described by using the column comparison circuit 210A as an example.

The column comparison circuit 210A includes capacitors C1, C2, and C3, transistors M1, M2, M3, and M4, switches SW1 and SW2, and a NOT circuit N1.

The capacitors C1 and C2 constitute an auto-zero capacitance. The capacitor C1 has an end connected to a vertical signal line VSL for every column. A ramp signal Ramp is input to one end of the capacitor C2. The other ends of the capacitors C1 and C2 are connected, a signal from the pixel is superimposed on the ramp signal Ramp, and a signal DIFFDAC is output.

The transistor M1 is, for example, a p-type metal-oxide-semiconductor field-effect transistor (MOSFET), and has a source connected to the column power supply controller 214, to which a power supply voltage VDDA is applied, and a gate connected to the capacitors C1 and C2, to which the DIFFDAC is applied.

The transistor M2 is, for example, an n-type MOSFET, and has a drain connected to a drain of the transistor M1 and a source connected to a power supply voltage VSS. The transistor M2 operates as a first current source. An appropriate bias voltage is applied to a gate of the transistor M2, and a drain current based on a potential of the drain flows.

A signal VOUT1 is output to a gate of the transistor M3 between the drains of the transistors M1 and M2.

The switch SW1 is connected between the gate and the drain of the transistor M1. The switch SW1 controls a short circuit and opening between the gate and the drain of the transistor M1 by an auto-zero signal AZP. When the switch SW1 is turned on, the gate of the transistor M1 is connected to the power supply voltage VSS via the transistor M2, and charges of the capacitors C1 and C2 are reset.

The transistor M3 is, for example, a p-type MOSFET, and has a source connected to the column power supply controller 214, to which the power supply voltage VDDA is applied, and a gate connected to the drain of the transistor M1.

The transistor M4 is, for example, an n-type MOSFET, and has a drain connected to the drain of the transistor M3, a gate connected to one end of the capacitor C3, and a source connected to the power supply voltage VSS. The transistor M4 operates as a second current source.

Between the drains of the transistors M3 and M4, a signal VOUT2 is output to the NOT circuit N1.

The capacitor C3 is a capacitor that generates a potential of the gate of the transistor M4 operating as the second current source.

The switch SW2 is connected between the gate and the drain of the transistor M4. The switch SW1 controls a short circuit and opening between the gate and the drain of the transistor M4 by an auto-zero signal AZN. When the switch SW2 is turned on, the gate of the transistor M4 is connected to the drain, and the potential of the gate is reset.

The NOT circuit N1 is a circuit that inverts and outputs an input, inverts the input VOUT2, and outputs an output signal OUT from the comparator. Note that, depending on the configuration, a clamp circuit may be connected before and after the NOT circuit N1. The clamp circuit may be a circuit that can selectively output from the comparator.

This circuit is a circuit presented as an example, and the circuit of the comparator for the column is not limited to the example of FIG. 6.

The column power supply controller 214 includes a selector 216 and local power supplies 218A, 218B, 218C, . . . . The column power supply controller 214 is a circuit that applies an appropriate power supply voltage to the column comparison circuits 210A, 210B, 210C, . . . corresponding to the respective columns to generate a dither effect.

The selector 216 is a circuit that receives input of a control signal Cnt and voltages V1, V2, and V3 serving as local power supplies and outputs an appropriate voltage to an appropriate output destination. The selector 216 selects which voltage to output to which column in accordance with the control signal Cnt.

The local power supply 218A is a circuit that controls and outputs a power supply voltage to the column comparison circuit 210A. The local power supply 218A is connected to a power supply voltage VDD, controls the voltage output from the selector 216 to a stable voltage, and outputs the power supply voltage VDDA to a power supply terminal of the column comparison circuit 210A. A similar configuration applies to the columns other than the column A. Each of the local power supplies 218 may include, for example, a regulator such as a low dropout (LDO). As the local power supply 218, it is desirable to use a regulator that outputs a stable voltage against a plurality of voltage values, for example, a regulator that can appropriately supply a stable voltage even if input/output voltages have a certain width.

For example, when a signal for setting the power supply voltage of the column comparison circuit 210A to V1 is input as the control signal Cnt, the selector 216 connects the power supply voltage V1 to the local power supply 218A. The local power supply 218A converts the input voltage into the voltage V1 which is stable and outputs the voltage V1 as a power supply voltage to the column comparison circuit 210A.

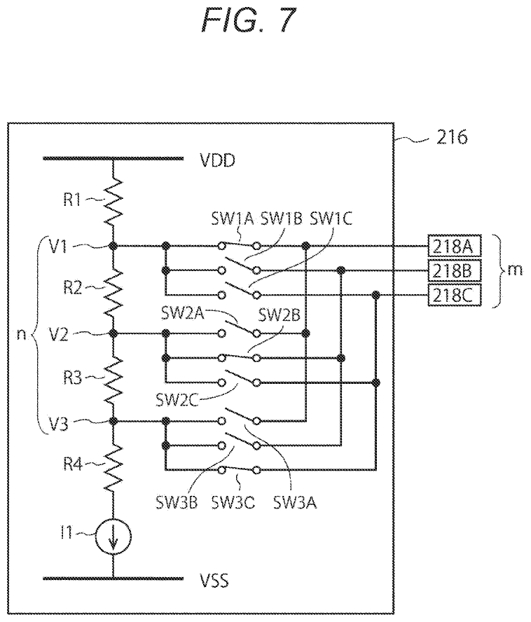

FIG. 7 is a circuit diagram illustrating a non-restrictive example of the selector 216. The selector 216 includes resistors R1, R2, R3, and R4, a current source I1, and switches SW1A, SW1B, SW1C, SW2A, SW2B, SW2C, SW3A, SW3B, and SW3C.

The resistors R1, R2, R3, and R4 and the current source I1 are connected in series between the power supply voltages VDD and VSS. These resistors and current sources generate different voltages at contacts between the resistors. For example, it is assumed that a potential at a node of the resistors R1 and R2 is V1, a potential at a node of the resistors R2 and R3 is V2, and a potential at a node of the resistors R3 and R4 is V3.

The switches SW1A, SW2A, and SW3A are exclusively controlled by the control signal Cnt. Similarly, the switches SW1B, SW2B, and SW3B and the switches SW1C, SW2C, and SW3C are exclusively controlled.

In the example of FIG. 7, the switches SW1A, SW2B, and SW3C are turned on, and the other switches are turned off. In such switch connection, the voltage V1 is output to the local power supply 218A, the voltage V2 is output to the local power supply 218B, and the voltage V3 is output to the local power supply 218C.

The above configuration enables application of a controlled power supply voltage to each comparator of the column on the basis of the control signal Cnt.

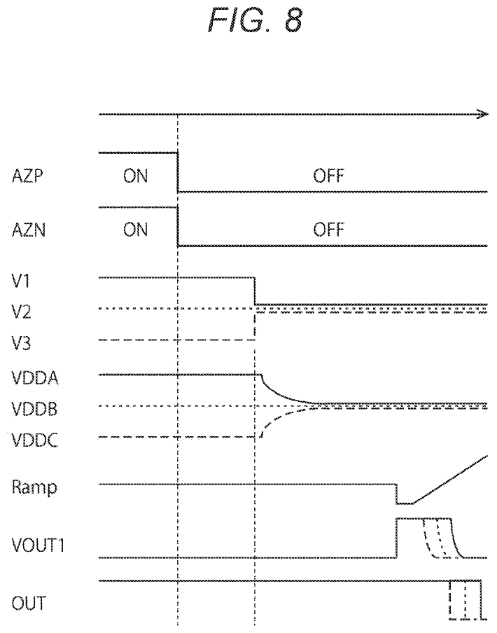

FIG. 8 is a timing chart in a case where the selector 216 is connected as shown in FIG. 7. As for a combination having a solid line, a dotted line, and a broken line, the solid line represents the power supply voltage V1 and input and output of a column in which the power supply voltage V1 is selected, a dotted line represents V2 and input and output of a column in which V2 is selected, and a broken line represents V3 and input and output of a column in which V3 is selected.

First, since AZP and AZN are turned on, the column comparison circuits 210A, 210B, 210C, . . . are reset. In this state, the column power supply controller 214 controls the voltages V1, V2, and V3. In this period, the respective capacitors in the column comparison circuit 210A and the like are appropriately set to reset levels on the basis of the power supply voltages V1, V2, and V3 applied to the respective columns.

In a state of preparation for reading the pixel signal, AZP and AZN are turned off. Subsequently, when V1 to V3 are reset, VDDA, VDDB, and VDDC transition to the reset level. For example, as in the example of FIGS. 8, V1 and V3 may be set to voltages equivalent to V2. Note that V1 and V3 are not necessarily set to V2, and are only required to be controlled so as to have the same potential at a timing of executing AD.

Thereafter, the ramp signal Ramp is appropriately applied, and then, VOUT1 is output at a timing based on the pixel value and the reset level of the capacitor. When a gate potential of the transistor M3 is changed by VOUT1, a signal based on a transition timing of VOUT1 is output from each of the column comparison circuits 210A and the like.

As described above, the timing of outputting OUT can be shifted by a difference in voltage among V1, V2, and V3, and the dither processing can be appropriately executed.

Next, selection of the power supply voltage in the selector 216 will be described.

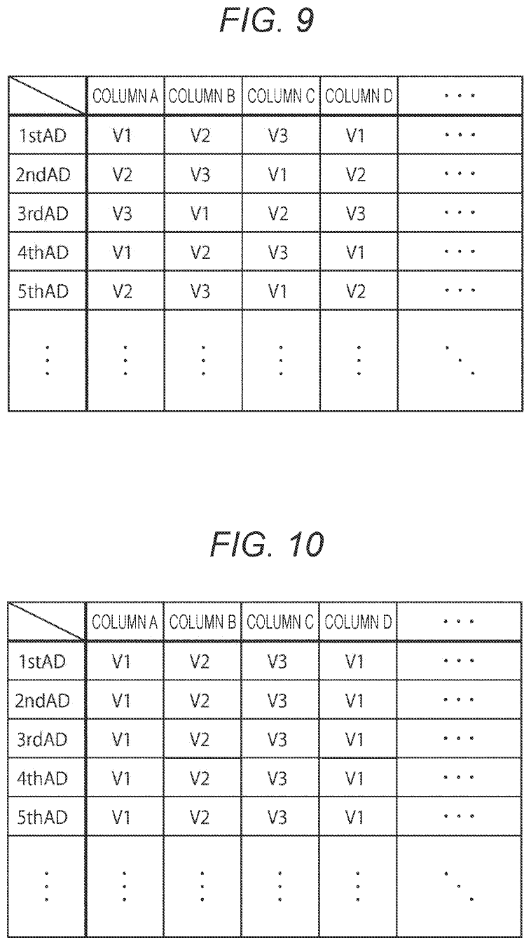

FIG. 9 is a table illustrating a non-restrictive example of the control by the column power supply controller 214. As shown in this drawing, three power supply voltages may be applied to three columns in order. As illustrated in this example, the power supply voltage applied to the column may be periodically controlled. By changing the power supply voltage in this manner, at the same timing, the dither processing can be executed in the column direction, and the dither processing in a time direction can be executed in the same column for every AD.

Note that, in FIG. 9, the power supply voltage is periodically changed. However, the present disclosure is not limited thereto, and the power supply voltage may be changed by a random number. Furthermore, the random number is not limited to a uniform random number, and may be, for example, a random number based on a normal distribution, a Poisson distribution, a binomial distribution, or the like. In a case where a random number is used, a different random number may be used for each column, or similarly to the above, the column A and the column D may have periodicity in the column direction so as to have the same power supply voltage. That is, the voltage applied to the column A is randomly determined, but the same power supply voltage may be always applied to the column A and the column D.

In this manner, the selector 216 may change an input/output relationship for every AD. By changing a device voltage applied to the same column for every AD by the selector 216, an output timing of P phase in the same column can be changed in the time direction.

FIG. 10 is a table illustrating another non-restrictive example of the control by the column power supply controller 214. As shown in this drawing, three power supply voltages may be applied to three columns regardless of time. In this case, as shown in FIG. 9, although the dither processing in the time direction cannot be achieved, the dither processing in the column direction can be appropriately executed.

In particular, control may be performed such that different power supply voltages are applied to adjacent columns. In addition, the voltage to be applied is not limited to adjacent columns, and the voltage to be applied in the column direction may be determined by a random number so that the same power supply voltage is not continuously applied to a predetermined value (for example, three or more columns) or the like.

As described above, in the present embodiment, the dither effect can be appropriately generated in the column direction and the time direction by applying the power supply voltage different for every column as the power supply voltage of the comparator. By performing the processing in this manner, it is possible to appropriately generate the dither effect in the image signal without increasing a count of the P phase. In addition, it is possible to apply a dither without a mismatch and increase a degree of freedom in designing the size of the transistor and the like. Furthermore, it is possible to appropriately control the count in the P phase without controlling the ramp signal in the P phase.

Note that, as described above, the types of the signals selected by the selector 216 and a column cycle in which the signals are allocated are not limited to three. For example, the selector 216 can allocate n (n>=2) types of power supply voltages in an m (m>=2) column cycle. In this case, the selector 216 includes an input line to which n types of potentials are input as the input of the power supply voltage, or includes a power supply capable of setting n types of potentials in the selector 216. Then, the selector 216 has a circuit configuration capable of appropriately and selectively outputting n types of power supply voltages to m types of columns.

For example, in FIG. 7, n=3 (V1, V2, V3) and m=3 (218A, 218B, 218C). Then, the column power supply controller 214 includes a circuit capable of generating n types of potentials and a selection circuit capable of controlling a connection relationship between n control lines. The n control lines are connected to a local power supply means corresponding to each column in the m-column cycle, for example.

### Second Embodiment

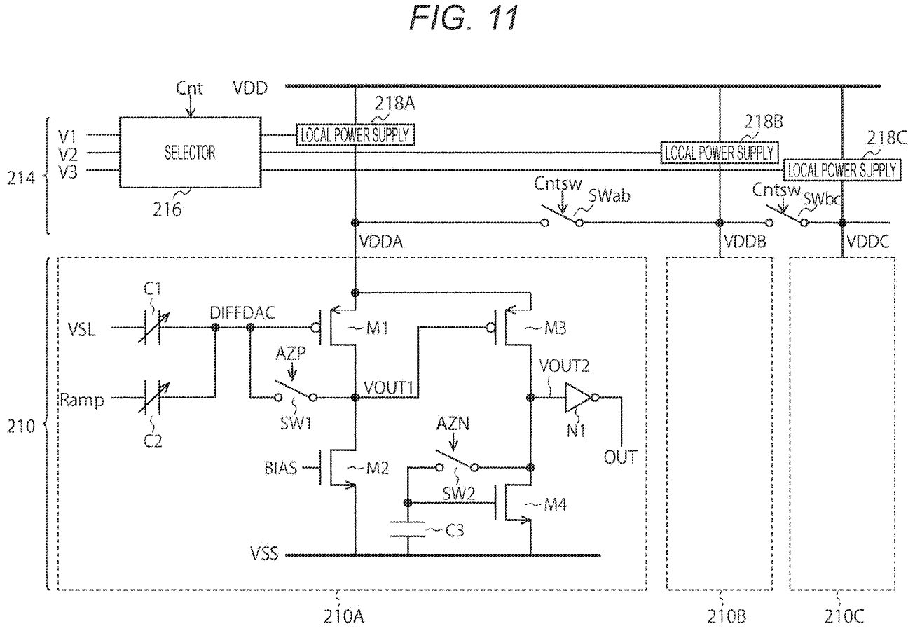

FIG. 11 is a circuit diagram illustrating an example of the column power supply controller 214 according to a second embodiment. In addition to the configuration of the foregoing embodiment, a switch for short-circuiting power supply voltage terminals of adjacent columns is further disposed.

For example, a switch SWab is disposed between lines to which the power supply voltage is applied between the columns A and B, and a switch SWbc is disposed between the columns B and C. These switches are controlled by a control signal Cntsw.

The column power supply controller 214 may further include a switch control circuit (not shown) that outputs the control signal Cntsw.

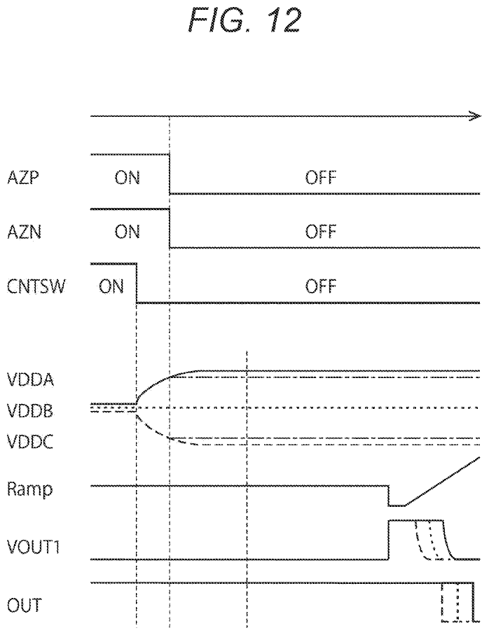

FIG. 12 is a timing chart in a case where the selector 216 is connected as illustrated in FIG. 11. As shown in FIG. 12, the control signal Cntsw is switched from on to off before AZP and AZN are switched from on to off. This timing is set such that VDDA or the like rises and auto-zeroing is turned off before the fall is completed. That is, the capacitor is reset for every column at the power supply voltage indicated by the alternate long and short dash line in the drawing.

Since such a power supply voltage is applied, a deviation occurs in an output timing from the comparison circuit for each column, similarly to the above-described embodiment.

As described above, in the present embodiment, it is also possible to perform control to vary the power supply voltage applied to every column. By superimposing this variation on the reset level of the AD conversion, it is possible to add variation to the count in the P phase. In the present embodiment, a dither amount can be controlled by timings of AZ and Cntsw. In addition, since a power supply potential is short-circuited between the columns and then varied, the short-circuited columns vary by the mismatch of Vth starting from the averaged potential. As a result, the average value itself of the power supply voltage does not vary.

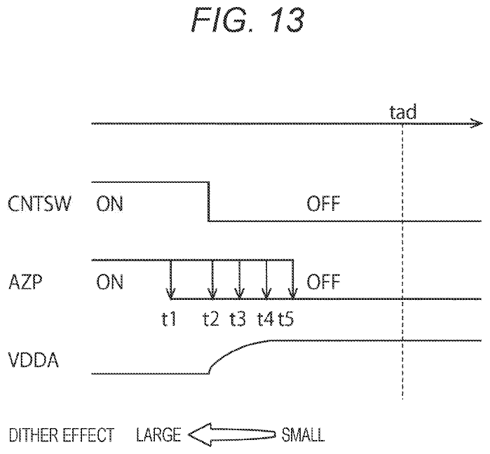

FIG. 13 is a diagram illustrating a relationship between the timings of AZP and Cntsw and a magnitude of the dither effect according to the present embodiment. Although it has been described above that Cntsw is switched from on to off before AZ, the present disclosure is not limited thereto. For example, AZP may be turned off first, and then Cntsw may be turned on. Alternatively, Cntsw and AZP may be turned on simultaneously. For example, in a case where V1 is higher than the average power supply voltage in the short-circuited column, the power supply potential of the column A connected to V1 transitions as V1 shown in FIG. 13. In this state, it is assumed that AD conversion is started from tad.

In a case where AZP is turned off at t1, a difference between VDDA at the time of resetting and VDDA at the time of AD conversion is larger than the difference at t2 to t5, and thus the dither amount is larger. On the other hand, in a case where AZP is turned off at t5, the difference between VDDA at the time of resetting and VDDA at the time of AD conversion is smaller than the difference at t1 to t3, and thus the dither amount is larger. In this manner, the dither amount can be controlled by a switching timing of AZP or a switching timing of Cntsw.

As described above, by controlling the timing of AZP and Cntsw, it is also possible to achieve processing of the dither similar to the dither in the time direction in the above-described embodiment. As another example, dithering/non-dithering may be switched for every AD conversion. For example, by controlling Cntsw turned off, the dithering processing is not performed in adjacent columns. By switching the dither for every AD conversion, the dither processing can be performed in the time direction.

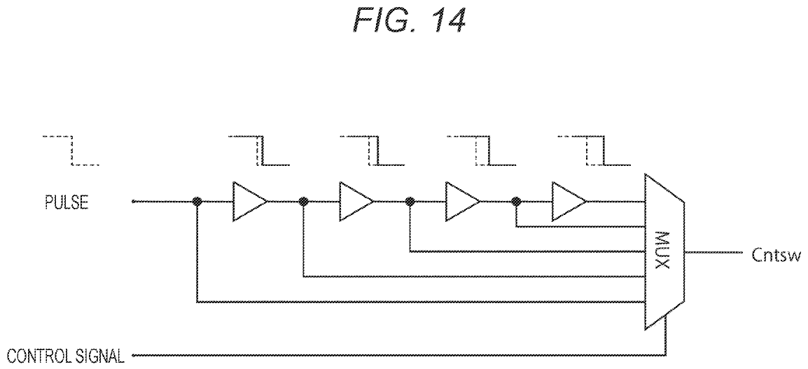

FIG. 14 is a circuit that generates Cntsw having different timings of falling from on to off. The control signal is a selection signal for controlling which of a plurality of input signals is selected by a multiplexer MUX.

Signals that pass through different numbers of buffers and have different timings of falling are input to the multiplexer MUX. Among the signals having different timings of falling, by outputting a desired signal from the multiplexer MUX by the control signal, it is possible to output a desired signal in a case where the dither amount is controlled at the timing as shown in FIG. 13. This circuit may of course be provided in the column power supply controller 214. A dotted line indicates the timing of an input pulse, and each buffer outputs a falling pulse indicated by a solid line at a different timing.

Similarly to the above-described embodiment, the control signal may be periodically set to an appropriate reset level for each column, or the setting may be updated by a random number or the like for every AD.

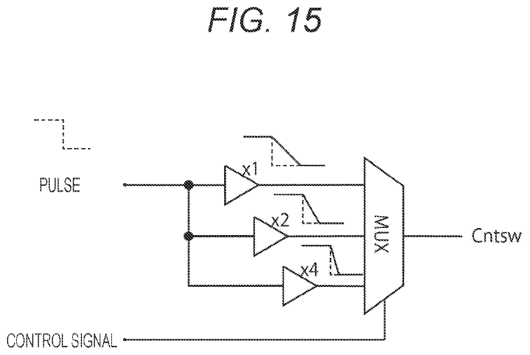

FIG. 15 is a circuit that virtually generates Cntsw having different timings of falling from on to off. The control signal may be periodic or random, similarly to the case of FIG. 14.

In the circuit in FIG. 15, a driving capability of the buffer input to the multiplexer MUX is different. Due to this difference in driving capability, for example, the output of each buffer outputs a sharper signal as the driving capability is higher, and a more blurred signal as the driving capability is lower, as illustrated in the upper right of the buffer. This signal is appropriately output from the multiplexer MUX by the control signal.

By setting such a signal having a different falling slope as Cntsw, the dither amount can be controlled by shifting a timing below a threshold voltage at which the switch SWab or the like is turned off.

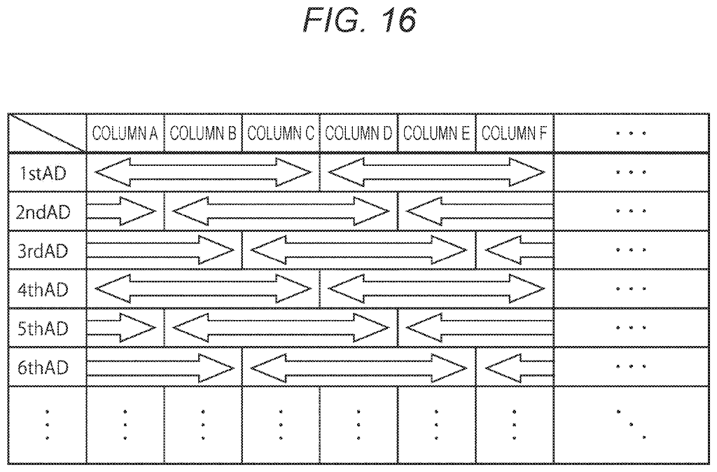

FIG. 16 is a table illustrating another example of controlling short-circuiting and opening for performing dithering in the time direction. The columns to which the same arrow belongs are columns to be short-circuited and opened in each AD conversion. In this manner, the columns to be short-circuited and opened may be changed for every AD conversion processing. In FIG. 16, a connection relationship of the columns is periodically controlled, but the connection relationship of the columns may be randomly controlled instead of periodically. For example, the control may be performed such that the connection relationship is shifted to either the right or the left as in a random walk (whether to move the position of arrows in FIG. 14 from left to right or not to move is selected).

### Third Embodiment

In each of the above-described embodiments, the comparison circuit that does not perform a differential operation is selected as the comparison circuit for each column, but the present disclosure is not limited thereto. For example, the method of the present disclosure can also be applied to a circuit that achieves comparison between a ramp signal and a signal from a pixel on the basis of a differential signal.

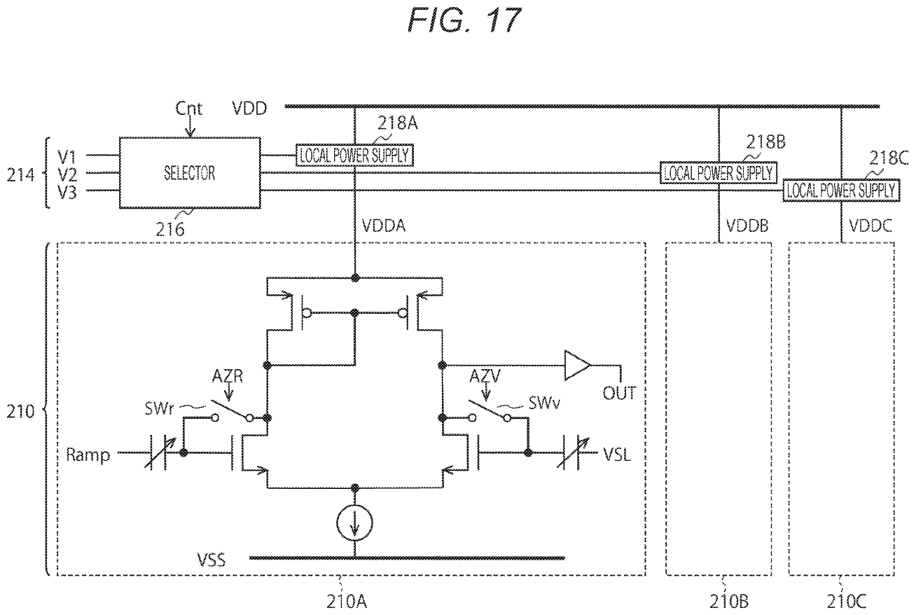

FIG. 17 is a circuit diagram illustrating the column comparison circuit 210A according to the present embodiment. The column comparison circuit 210A receives the ramp signal Ramp and a signal from the vertical signal line VSL from the pixel as differential inputs, and acquires a timing signal in a counter circuit on the basis of a difference between the signals. Note that this circuit is described as a non-restrictive example of a comparator using a differential amplifier, and can be similarly applied to other circuits.

For example, as shown in the drawing, the switches SWr and SWv are connected between a gate and a drain of an n-type MOSFET which is an input terminal of each signal installed in a lower stage. By the auto-zero signals AZR and AZV, respective input transistors are appropriately reset.

Generally, in such a differential amplifier type, AZR and AZV are switched on and off simultaneously, but in the present embodiment, a dither effect similar to the dither effect in the first embodiment can be obtained by shifting the timing.

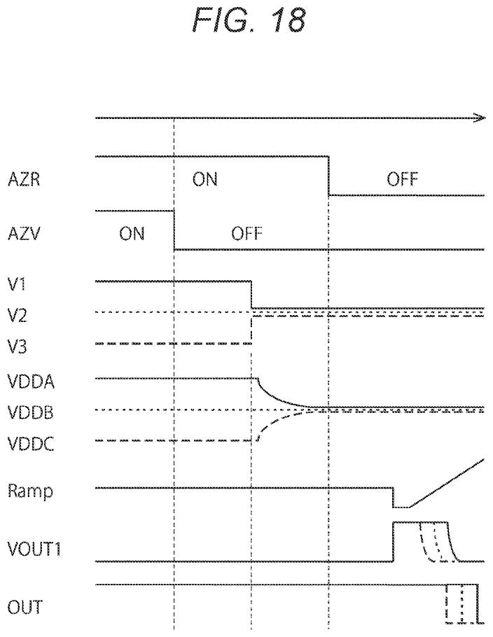

FIG. 18 is a diagram illustrating an example of a timing chart according to the present embodiment. As shown in FIG. 18, first, before controlling V1 and the like, the AZV is turned off to release a reset state of the transistor to which the signal from the pixel is input.

Subsequently, the reset level of the capacitor on the ramp signal side is varied by controlling V1 and the like.

Then, AZR is turned off to release the reset state of the transistor on the ramp signal input side when VDDA or the like transitions to a steady state.

Such control can exhibit a dither effect by varying a reset level for receiving a signal from a pixel and a reset level for receiving a ramp signal.

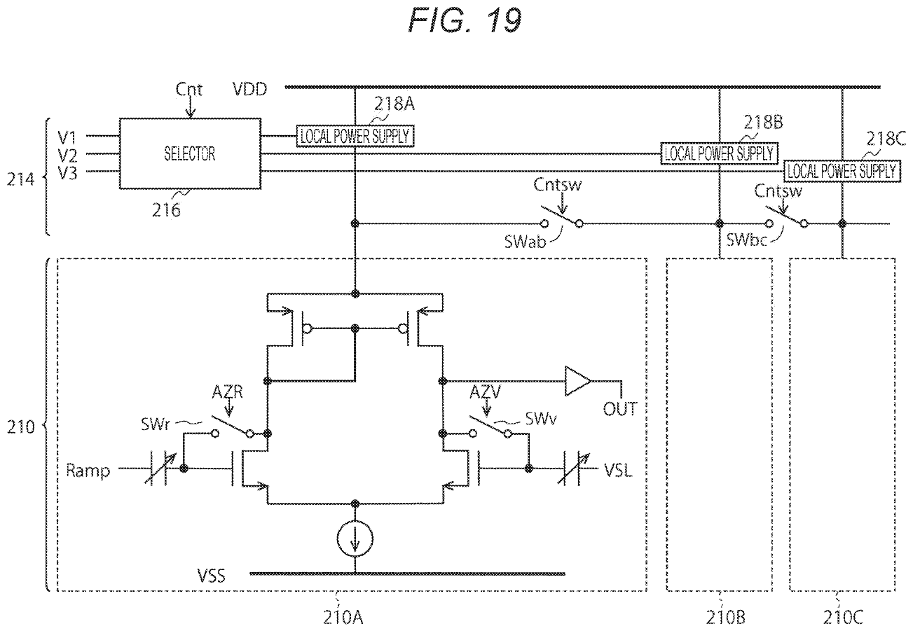

FIG. 19 illustrates a differential input type of the comparison circuit according to the second embodiment. The configuration is similar to the configuration in FIG. 17 except that there is a switch that short-circuits and opens the columns. That is, the configuration is presented as a non-restrictive example as a comparator that receives a differential input.

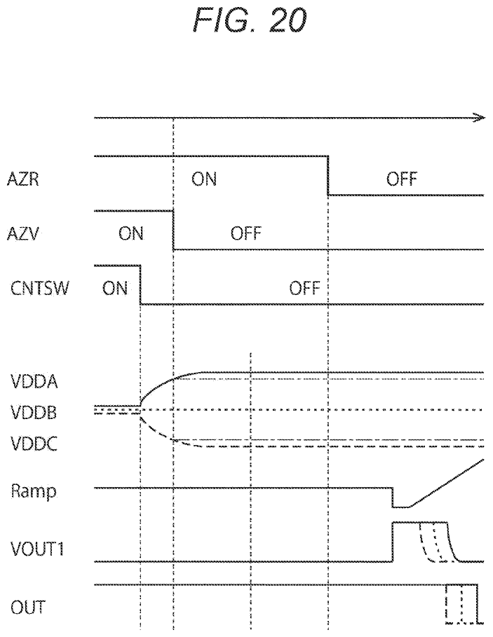

FIG. 20 is a diagram illustrating a timing chart in the case of FIG. 19. In this case, similarly, after Cntsw is turned off, AZV is first turned off to set the reset level of the transistor on the pixel side. Thereafter, the reset level of the input transistor on the ramp signal side is set.

By controlling in this manner, the reset level is varied, and it is possible to achieve appropriate dither processing similarly to the second embodiment.

The technology of the present disclosure (present technology) can be applied to various products. For example, the technology of the present disclosure may be implemented as a device mounted on any type of mobile body such as an automobile, an electric vehicle, a hybrid electric vehicle, a motorcycle, a bicycle, a personal mobility, an airplane, a drone, a ship, a robot, and the like.

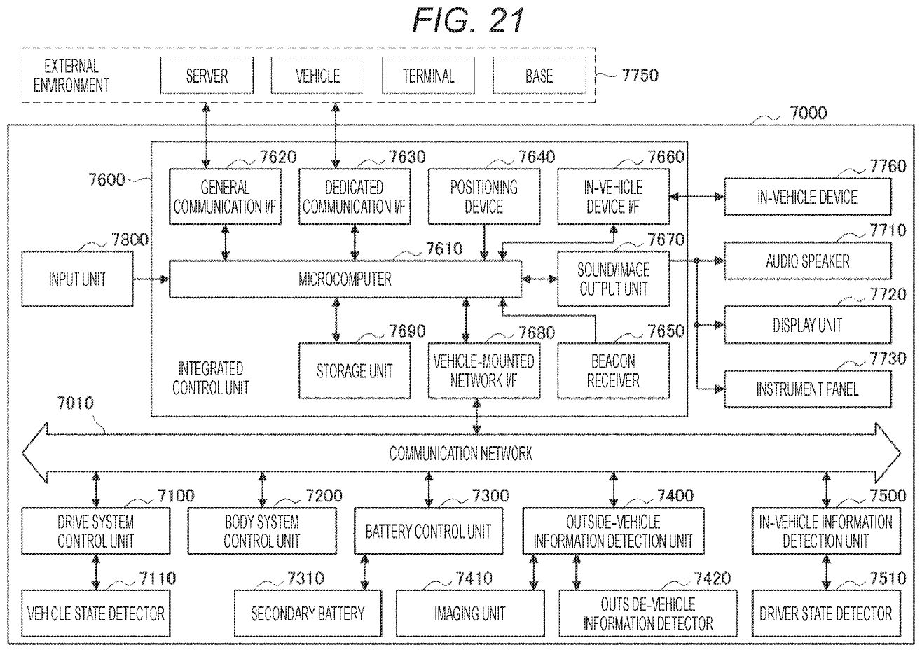

FIG. 21 is a block diagram illustrating a schematic configuration example of a vehicle control system as an example of a vehicle control system to which the technology of the present disclosure is applied.

The vehicle control system 12000 includes a plurality of electronic control units connected to each other via a communication network 12001. In the example illustrated in FIG. 21, the vehicle control system 12000 includes a drive system control unit 12010, a body system control unit 12020, an outside-vehicle information detection unit 12030, an in-vehicle information detection unit 12040, and an integrated control unit 12050. In addition, a microcomputer 12051, a sound/image output unit 12052, and a vehicle-mounted network interface (I/F) 12053 are illustrated as a functional configuration of the integrated control unit 12050.

The drive system control unit 12010 controls the operation of devices related to a drive system of a vehicle in accordance with various programs. For example, the drive system control unit 12010 functions as a control device for a driving force generator for generating a driving force of the vehicle, such as an internal combustion engine, a driving motor, or the like, a driving force transmission mechanism for transmitting the driving force to wheels, a steering mechanism for adjusting a steering angle of the vehicle, a braking device for generating a braking force of the vehicle, and the like.

The body system control unit 12020 controls the operation of various devices mounted on a vehicle body in accordance with various programs. For example, the body system control unit 12020 functions as a control device for a keyless entry system, a smart key system, a power window device, or various lamps such as a headlamp, a back lamp, a brake lamp, a turn indicator, or a fog lamp. In this case, radio waves transmitted from a portable device or signals of various switches as an alternative to a key can be input to the body system control unit 12020. The body system control unit 12020 receives these input radio waves or signals, and controls a door lock device, a power window device, lamps, or the like of the vehicle.

The outside-vehicle information detection unit 12030 detects information regarding the outside of the vehicle equipped with the vehicle control system 12000. For example, an imaging unit 12031 is connected to the outside-vehicle information detection unit 12030. The outside-vehicle information detection unit 12030 causes the imaging unit 12031 to image an image of the outside of the vehicle, and receives the imaged image. On the basis of the received image, the outside-vehicle information detection unit 12030 may perform processing of detecting an object such as a human, a vehicle, an obstacle, a sign, a character on a road surface, or the like, or processing of detecting a distance to the object.

The imaging unit 12031 is an optical sensor that receives light and outputs an electric signal corresponding to an amount of the received light. The imaging unit 12031 can output the electric signal as an image, or can output the electric signal as information regarding a measured distance. In addition, the light received by the imaging unit 12031 may be visible light, or may be invisible light such as infrared rays or the like.

The in-vehicle information detection unit 12040 detects information regarding the inside of the vehicle. For example, a driver state detector 12041 that detects a state of a driver is connected to the in-vehicle information detection unit 12040. The driver state detector 12041, for example, includes a camera that images the driver. On the basis of detection information input from the driver state detector 12041, the in-vehicle information detection unit 12040 may calculate a degree of fatigue of the driver or a degree of concentration of the driver, or may determine whether or not the driver is dozing.

The microcomputer 12051 can calculate a control target value of the driving force generator, the steering mechanism, or the braking device on the basis of the information regarding the inside or outside of the vehicle which information is obtained by the outside-vehicle information detection unit 12030 or the in-vehicle information detection unit 12040, and output a control command to the drive system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generator, the steering mechanism, the braking device, or the like on the basis of the information regarding surroundings of the vehicle which information is obtained by the outside-vehicle information detection unit 12030 or the in-vehicle information detection unit 12040.

Furthermore, the microcomputer 12051 can output a control command to the body system control unit 12030 on the basis of the information regarding the outside of the vehicle which information is obtained by the outside-vehicle information detection unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detection unit 12030.

The sound/image output unit 12052 transmits an output signal of at least one of a sound or an image to an output device capable of visually or auditorily notifying an occupant of the vehicle or the outside of the vehicle of information. In the example of FIG. 21, an audio speaker 12061, a display unit 12062, and an instrument panel 12063 are illustrated as the output device. The display unit 12062 may, for example, include at least one of an on-board display or a head-up display.

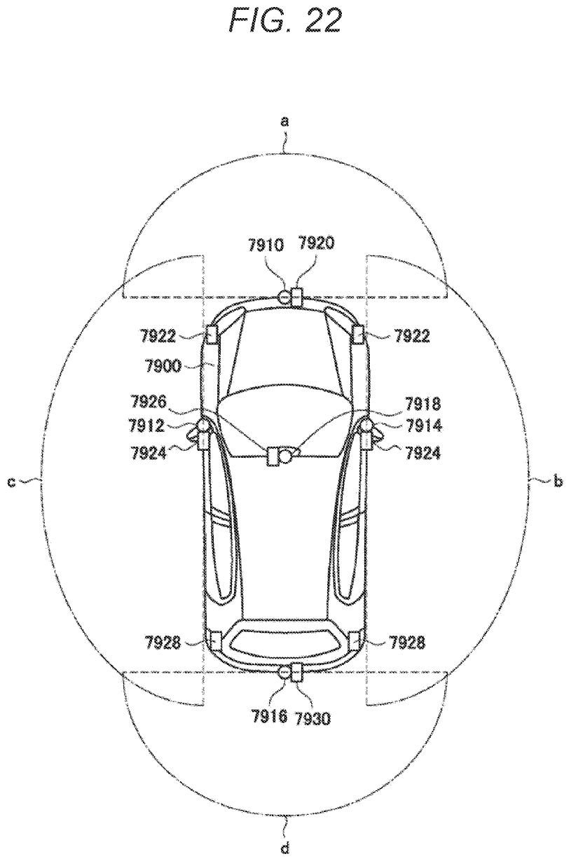

FIG. 22 is a diagram illustrating an example of the installation position of the imaging unit 12031.

In FIG. 22, imaging units 12101, 12102, 12103, 12104, and 12105 are provided as the imaging unit 12031.

The imaging units 12101, 12102, 12103, 12104, and 12105 are provided at positions such as, for example, a front nose, side-view mirrors, rear bumper, and back door of a vehicle 12100, and an upper part of a windshield, or the like, of an interior of the vehicle. The imaging unit 12101 provided on the front nose and the imaging unit 12105 provided in the upper part of the windshield of the interior of the vehicle mainly obtain the image of ahead of the vehicle 12100. The imaging units 12102 and 12103 provided on the side-view mirrors mainly obtain an image of the sides of the vehicle 12100. The imaging unit 12104 provided on the rear bumper or the back door obtains mainly an image of behind the vehicle 12100. The imaging unit 12105 provided on the upper part of the windshield in the interior of the vehicle is used mainly to detect a preceding vehicle, a pedestrian, an obstacle, a signal, a traffic sign, a lane, and the like.

Note that FIG. 22 illustrates an example of imaging ranges of the imaging units 12101 to 12104. An imaging range 12111 represents an imaging range of the imaging unit 12101 provided on the front nose. Imaging ranges 12112 and 12113 respectively represent imaging ranges of the imaging units 12102 and 12103 provided on the side-view mirrors. An imaging range 12114 represents an imaging range of the imaging unit 12104 provided on the rear bumper or the back door. A bird's-eye image of the vehicle 12100 as viewed from above is obtained by superimposing image data imaged by the imaging units 12101 to 12104, for example.

At least one of the imaging units 12101 to 12104 may have a function of obtaining distance information. For example, at least one of the imaging units 12101 to 12104 may be a stereo camera including a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging units 12101 to 12104, and thereby extract, as a preceding vehicle, particularly, a nearest three-dimensional object that is present on a traveling path of the vehicle 12100 and which travels in substantially the same direction as the vehicle 12100 at a predetermined speed (for example, equal to or more than 0 km/hour). Furthermore, the microcomputer 12051 can set a following distance to be maintained in front of a preceding vehicle in advance, and perform automatic brake control (including following stop control), automatic acceleration control (including following start control), and the like. It is thus possible to perform cooperative control intended for automated driving that makes the vehicle travel autonomously without depending on the operation of the driver, or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging units 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display unit 12062, and performs forced deceleration or avoidance steering via the drive system control unit 12010. The microcomputer 12051 can thereby assist in driving to avoid collision.

At least one of the imaging units 12101 to 12104 may be an infrared camera that detects infrared rays. The microcomputer 12051 can, for example, recognize a pedestrian by determining whether or not there is a pedestrian in imaged images of the imaging units 12101 to 12104. Such recognition of a pedestrian is, for example, performed by a procedure of extracting characteristic points in the imaged images of the imaging units 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging units 12101 to 12104, and thus recognizes the pedestrian, the sound/image output unit 12052 controls the display unit 12062 so that a square contour line for emphasis is displayed so as to be superimposed on the recognized pedestrian. Furthermore, the sound/image output unit 12052 may control the display unit 12062 to display, at a desired position, an icon or the like indicating a pedestrian.

An example of a vehicle control system to which the technology of the present disclosure can be applied has been described above. The technology of the present disclosure can be applied to the imaging unit 12031 among the configurations described above. Specifically, the solid-state imaging device in FIG. 1 and the like and the solid-state imaging element in FIG. 5 and the like can be applied to the imaging unit 12031.

The embodiments described above may have the following forms.

(1)

A solid-state imaging element includes
a pixel array in which pixels that photoelectrically convert received light and output signals are provided in an array,
a horizontal direction controller that selects a line of the pixel array and controls output of the signals from the pixels belonging to the line,
a comparator including a plurality of column comparison circuits that compares the signals output from the pixels for every column of the pixel array, and
a column power supply controller that controls a power supply voltage for each of the plurality of column comparison circuits.

(2)

In the solid-state imaging element according to (1), the column power supply controller applies n (n>=2) types of power supply voltages to each of the plurality of column comparison circuits.

(3)

In the solid-state imaging element according to (2), the column power supply controller includes a circuit configured to generate n types of potentials.

(4)

In the solid-state imaging element according to (3), the column power supply controller includes n control lines that transmit the n types of potentials.

(5)

In the solid-state imaging element according to (4), the column power supply controller applies a same power supply voltage to every m (m>=2) column comparison circuits among the plurality of column comparison circuits.

(6)

In the solid-state imaging element according to (5), the column power supply controller includes a selector that connects the n control lines to the plurality of column comparison circuits at an m-column cycle.

(7)

In the solid-state imaging element according to (6), the selector transitions a connection status between the n control lines and the plurality of column comparison circuits in the m-column cycle for every AD conversion.

(8)

In the solid-state imaging element according to (7), the selector transitions the connection status for every AD conversion periodically with respect to time.

(9)

In the solid-state imaging element according to (7), the selector transitions the connection status for every AD conversion on the basis of a random number.

(10)

In the solid-state imaging element according to any of (2) to (9),
the column power supply controller, to the n control lines,
outputs the n types of potentials at a timing of resetting the plurality of column comparison circuits, and
outputs one type of potential at a timing of AD conversion.

(11)

In the solid-state imaging element according to (1),
the column power supply controller includes
a switch that controls short-circuiting and opening of a power supply line that applies the power supply voltage to each of the plurality of column comparison circuits to the power supply line of another column comparison circuit among the plurality of column comparison circuits, and
a switch control circuit that transmits a switch control signal that controls a switching state of the switch.

(12)

In the solid-state imaging element according to (11), the column power supply controller varies the power supply voltage of each of the plurality of column comparison circuits at the timing of resetting the plurality of column comparison circuits and at the timing of AD conversion.

(13)

In the solid-state imaging element according to (11), the column power supply controller controls whether or not the power supply voltage is varied for every AD conversion of the plurality of column comparison circuits.

(14)

In the solid-state imaging element according to (11), the column power supply controller controls the switch for every AD conversion, and varies a combination of the column comparison circuits to be short-circuited.

(15)

A solid-state imaging device includes
an optical system that controls a light receiving environment in the pixels,
the solid-state imaging element according to any of (1) to (14), and
a processing circuit that processes a signal output from the solid-state imaging element.

Aspects of the present disclosure are not limited to the above-described embodiments, and include various conceivable modifications. The effects of the present disclosure are not limited to the above-described contents. The components in each of the embodiments may be appropriately combined and applied. That is, various additions, modifications, and partial deletions can be made without departing from the conceptual idea and gist of the present disclosure derived from the contents defined in the claims and equivalents and the like thereof.

### REFERENCE SIGNS LIST

1 Solid-state imaging device
10 Optical system
12 Power supply unit
14 Operation unit
16 Controller
18 Display unit
20 Solid-state imaging element
22 Storage unit
24 Processor
200 Light receiving element
202 Storage circuit
204 Processing circuit
206 Pixel
208 Horizontal direction controller
210 Comparator
212 Counter
214 Column power supply controller
216 Selector
218 Local power supply

1. A solid-state imaging element comprising:
a pixel array in which pixels that photoelectrically convert received light and output signals are provided in an array;
a horizontal direction controller that selects a line of the pixel array and controls output of the signals from the pixels belonging to the line;
a comparator including a plurality of column comparison circuits that compares the signals output from the pixels for every column of the pixel array; and
a column power supply controller that controls a power supply voltage for each of the plurality of column comparison circuits.

2. The solid-state imaging element according to claim 1, wherein the column power supply controller applies n (n>=2) types of power supply voltages to each of the plurality of column comparison circuits.

3. The solid-state imaging element according to claim 2, wherein the column power supply controller includes a circuit configured to generate n types of potentials.

4. The solid-state imaging element according to claim 3, wherein the column power supply controller includes n control lines that transmit the n types of potentials.

5. The solid-state imaging element according to claim 4, wherein the column power supply controller applies a same power supply voltage to every m (m>=2) column comparison circuits among the plurality of column comparison circuits.

6. The solid-state imaging element according to claim 5, wherein the column power supply controller includes a selector that connects the n control lines to the plurality of column comparison circuits at an m-column cycle.

7. The solid-state imaging element according to claim 6, wherein the selector transitions a connection status between the n control lines and the plurality of column comparison circuits in the m-column cycle for every AD conversion.

8. The solid-state imaging element according to claim 7, wherein the selector transitions the connection status for every AD conversion periodically with respect to time.

9. The solid-state imaging element according to claim 7, wherein the selector transitions the connection status for every AD conversion on a basis of a random number.

10. The solid-state imaging element according to claim 2, wherein
the column power supply controller, to the n control lines,
outputs the n types of potentials at a timing of resetting the plurality of column comparison circuits, and
outputs one type of potential at a timing of AD conversion.

11. The solid-state imaging element according to claim 1, wherein
the column power supply controller includes
a switch that controls short-circuiting and opening of a power supply line that applies the power supply voltage to each of the plurality of column comparison circuits to the power supply line of another column comparison circuit among the plurality of column comparison circuits, and
a switch control circuit that transmits a switch control signal that controls a switching state of the switch.

12. The solid-state imaging element according to claim 11, wherein the column power supply controller varies the power supply voltage of each of the plurality of column comparison circuits at the timing of resetting the plurality of column comparison circuits and at the timing of AD conversion.

13. The solid-state imaging element according to claim 11, wherein the column power supply controller controls whether or not the power supply voltage is varied for every AD conversion of the plurality of column comparison circuits.

14. The solid-state imaging element according to claim 11, wherein the column power supply controller controls the switch for every AD conversion, and varies a combination of the column comparison circuits to be short-circuited.

15. A solid-state imaging device comprising:
an optical system that controls a light receiving environment in the pixels;
the solid-state imaging element according to claim 1; and
a processing circuit that processes a signal output from the solid-state imaging element.
